(19) United States
(12) Patent Application Publication
(10) Pub. No.: US 2024/0280292 A1
(43) Pub. Date: Aug. 22, 2024

(54) HEATING DEVICES AND SYSTEMS

(71) Applicant: AWD INNOVATIONS LIMITED, Glasgow (GB)

(72) Inventor: Andrew DEVERELL, Glasgow (GB)

(21) Appl. No.: 18/571,381

(22) PCT Filed: Jun. 15, 2022
(86) PCT No.: PCT/GB2022/051514

§ 371 Date: Dec. 18, 2023

(30) Foreign Application Priority Data
Jun. 18, 2021 (GB) 2108829.9

(51) Int. Cl. F24H 1/44; F24H 15/25; H05B 6/10

(52) U.S. Cl. CPC F24H 1/44; F24H 15/25; H05B 6/108; F24H 2250/08; H05B 2213/04

(57) ABSTRACT

The present invention relates to induction heating devices and systems. More particularly, the present invention relates to induction heating systems that may be used with, or include, radiators. A heating system described herein includes a radiator and an induction heating device attachable to the radiator, the induction heating device configured to heat at least a portion of the radiator via induction.

### INTRODUCTION

The present invention relates to induction heating devices and systems. More particularly, the present invention relates to induction heating systems that may be used with, or include, radiators.

Traditional heating systems have used a variety of methods of increasing the temperature of spaces such as rooms, vehicles, outdoor areas, and the like. Heating systems used in buildings typically heat a fluid which is then distributed to the parts of the building which require heating. Some examples include one or more radiators that may be heated by boilers such as gas boilers which increase the temperature of a liquid at a central boiler before distributing the heated fluid to one or more radiators throughout the heating system. Other boiler or furnace based systems heat air directly before distributing the heated air to desired areas. Historically, many such boiler systems have heated fluids via combustion of carbonaceous fuels such as natural gas or other fossil fuel derived materials. Combustion of carbonaceous fuels is increasingly considered environmentally undesirable. However, it is estimated that in some countries, up to 80% of domestic properties use gas boiler heating systems. Moreover, increased environmental awareness and more stringent government regulations mean that traditional boiler-based heating systems are either discouraged or, in some cases, to be banned at a national level. Many new buildings also lack connections to a gas or hydrocarbon fuel network. There is therefore a need for alternative heating solutions which may replace or adapt traditional approaches to spatial heating.

The inventor of the present invention has appreciated that induction heating may be used in conjunction with, or in place of, existing heating systems to reduce or eliminate the need to use hydrocarbon fuels such as natural gas to heat spaces. In this context, the term ‘induction heating’ means the heating of an electrically conductive material through the principle of electromagnetic induction. Induction heating operates via the principle of formation of eddy currents within a material which in turn causes the temperature of the material to increase. Induction heating systems typically include an electromagnet and an oscillator that causes a high frequency alternating current to be passed through the electromagnet. The alternating current results in a magnetic field which penetrates the material to be heated and generates electric currents, or eddy currents, inside the material.

According to one aspect of the invention, there is provided a heating system including a radiator and an induction heating device attachable to the radiator. The induction heating device is configured to heat at least a portion of the radiator via induction. The induction heating device may be removably attached to the exterior of the radiator. The radiator may include a ferrous metal and the induction heating device may be attached to the radiator using one or more magnets. The induction heating device may be configured to at least partly detach from the radiator at a fail-safe temperature. Where the induction heating device is attached to the radiator using one or more magnets, at least one of the one or more magnets may detach from the radiator at the fail-safe temperature. The induction heating device may be integral to the radiator. The induction heating device may have a power rating of less than 1500 W. The induction heating device may have a power rating of less than 500 W, less than 400 W, less than 300 W, or less than 200 W. The induction heating device may include a heat sink configured to transmit heat to at least a portion of the radiator. The radiator may include iron, cast iron, steel, mild steel, stainless steel, aluminium, any other ferrous metal, or any combination thereof. The radiator may include stainless steel. The radiator may house a fluid and the induction heating device may be configured to heat the fluid housed in the radiator. The heating system may include a controller configured to receive instructions to operate the heating system. The instructions may include instructions to heat the radiator, stop heating the radiator, increase the rate of heating of the radiator, decrease the rate of heating of the radiator, or any combination thereof. The heating system may include one or more sensors configured to detect a non-radiator object in proximity to or adjacent to the heating system. The one or more sensors may include an electromagnetic sensor, and/or an electrical current sensor. The system may include one or more temperature sensors configured to detect the temperature of the radiator, the ambient environment in proximity to the radiator, or any combination thereof. The heating system may be configured to maintain the temperature of the radiator and/or ambient environment in proximity to the radiator within a first temperature range. The first temperature range may be from 25 ° C. to 70° C., optionally wherein the first temperature range is from 30° C. to 45° C. The first temperature range may be a temperature range defined by the user. The induction heating device may be controlled remotely via an app. The heating system may include a plurality of radiators and a plurality of induction heating devices. The plurality of radiators and each of the plurality of induction heating devices may be substantially identical. Each of the plurality of induction heating devices may be individually controllable.

According to another aspect of the invention, there is provided an induction heating device for use in a heating system as described herein. The induction heating device may include a housing and a heating coil at least partially contained within the housing. The induction heating device may further include a temperature sensor; and/or a boost system comprising a boost button configured to activate the induction heating device and/or one or more circuit boards configured to control the heating coil and/or the boost system and/or a wireless network system configured to receive instructions to operate the induction heating device. The induction heating device may include an electrical power supply. The electrical power supply may be powered solely by renewable energy sources.

According to a further aspect of the invention, there is provided a method of retrofitting a radiator. The method includes attaching an induction heating device to a radiator to provide a heating system as described herein. The radiator may be compatible with a gas boiler heating system. These aspects and others will be apparent to the skilled practitioner in the art with the benefit of this disclosure. For the avoidance of doubt, the scope of the invention is defined by the appended claims.

### BRIEF DESCRIPTION OF THE DRAWINGS

The present invention will be described with reference to the following drawings, in which:

FIG. 1 shows a schematic of an induction heating device.

FIG. 2 shows an example of a system utilising multiple induction heating devices.

### DETAILED DESCRIPTION

Induction heating devices may be used as part of a heating system. Such heating systems may heat buildings, vehicles, outdoor spaces, or any other suitable area. Where a heating system is used to heat a building, the building may be a domestic residence, a public building, or a place of business such as an office, factory, warehouse, or the like. An induction heating system will generally include at least one radiator and an induction heating device attached, or attachable, to the radiator. In use or operation, the induction heating device heats at least a portion of the radiator via induction. The radiator, once heated, then heats a fluid flowing through, or in proximity to, the radiator to directly or indirectly impart heat to a desired space.

An induction heating device will generally include an induction coil to enable the device to generate an electromagnetic field to induce the induction effect. The coil may be an induction coil of any suitable design. Examples of suitable induction coils include standard coils, ‘pancake’ coils, elongated coils, multi-turn coils, rectangular coils, spiral coils, or any other suitable coil designs. The induction coil may be contained at least partially within a housing. The housing may be of any suitable shape or configuration that allows the device to be attached to a radiator and the coil to be contained at least partially within the housing. For example, the housing may be a three-dimensional shape with a square, rectangular, triangular, hemispherical, rounded, or irregular cross sectional area. The housing may be elongate such that it may rest against the length and/or height of a radiator. The housing may be formed from any suitable material. For example, the housing may be formed from a non-conductive material such as plastic, glass, ceramics, or the like. In other examples, the housing may include one or more conductive materials which may provide a conductive path to earth to enhance the user-safety of the device.

When the induction heating device is used in conjunction with a radiator, the induction heating device may be attached or removably attached to the radiator by any suitable means. In some examples, the induction heating device may be directly affixed to the radiator by one or more mechanical fastenings such as clamps, screws, bolts, pins, braces, or the like. In other examples, the induction heating device may be attached to the radiator by an adhesive such as a glue, resin, or the like. In examples where the radiator is formed from one or more ferrous materials, the induction heating device may be attached to the radiator using one or more magnets. In practice, any suitable means of attaching the induction heating device to a radiator may be combined with any other suitable attachment means. The attachment means may be configured such that the induction device ‘fails safe’ and detaches from the radiator in the event that the temperature of the radiator increases beyond a safe threshold. When the attachment means is configured in this manner, the temperature at which the induction heating device detaches from the radiator may be referred to as the fail-safe temperature. In examples where adhesives are used, the adhesives may be selected such that they have a melting point and/or boiling point at or just above the fail-safe temperature. In examples where one or more magnets are used, the magnets may be selected such that their magnetic properties are sufficiently diminished beyond the fail-safe temperature such that the induction heating device at least partly detaches from the radiator. In one particular example, the induction heating device may use at least two magnets with different thermal behaviour profiles with one magnet positioned further from the floor or ground than the other. In this example, the magnet further from the floor or ground may exhibit diminished magnetic properties at a lower temperature than the magnet closer to the floor such that the upper portion of the induction heating device falls away from a radiator at the fail-safe temperature while preventing the device from falling to the ground due to the continued attachment of the magnet closer to the floor or ground. In other examples, the device may be attached to the radiator by a combination of different attachment means, including in one example a mechanical fastening in a lower portion and a magnet in an upper portion, arranged such that at the fail-safe temperature the magnet exhibits diminished magnetic properties and the upper portion falls away from the radiator to a sufficient extent to prevent or significantly reduce continued induction heating, but the device remains attached to the radiator by the mechanical fastening to prevent it falling to the ground. In a particular example, the one or more magnets may exhibit diminished magnetic properties at or above 80° C. It may be advantageous to select a fail-safe temperature at or below 100° C. to reduce the risk and/or severity of burns being inflicted on a user in the event of an accident. More particularly, it may be advantageous to select a fail-safe temperature at or below 50° C., 48° C., 46° C., 44° C., 42° C., 40° C., 38° C., 36° C., 34° C., 32° C., 30° C. or less than 30° C.

The induction heating device may be integral to a radiator. That is, the induction heating device, when attached to the radiator, may form part of the radiator itself. In examples where the induction heating device is integral to the radiator the housing of the induction heating device may form part of the outer shell of the radiator. In other examples, the housing of the induction heating device may be the outer shell of the radiator. In other examples, the housing of the induction heating device may form a sub-compartment of the radiator. An integral induction heating device may be at least partly, or wholly, contained within a radiator. Where the radiator is a fluid radiator, the induction heating device may form at least part of the outer periphery of one or more cavities or volumes of the radiator that contain the radiator fluid.

The induction heating device may have a power rating sufficient to heat a radiator to a desired temperature within a desired timeframe. Induction heating provides an efficient conversion of electrical energy into heat energy across a rapid timeframe and consequently an induction heating device with a relatively low power rating may be used. The induction heating device may have any suitable power rating depending on the environment and requirements of the device. In some examples, the induction heating device may have a power rating of more than or equal to 1500 W, 1800, or 2000 W. In examples where a low power rating is used, the induction heating device may have a power rating of less than 1500 W. In more particular examples, the induction heating device may have a power rating of less than 1000 W, less than 750 W, less than 500 W, less than 400 W, less than 300 W, or less than 200 W. The power rating of the induction heating device may be selected to heat a standard domestic radiator to a temperature of 45° C. from a starting temperature of 10° C. in a period of less than 90 seconds, less than 120 seconds, less than 150 seconds, less than 180 seconds, less than 210 seconds, less than 240 seconds, less than 300 seconds, less than 450 seconds, or less than 600 seconds. The induction heating device may be electrically powered by one or more electrical power supplies. The electrical power supply of the induction heating device may be any suitable electrical power source such as a conventional wall socket power source, a mains power connection, an electrical battery, an integrated energy supply, or the like. The electrical power supply may be powered solely by renewable energy sources such as solar, wind, or tidal energy. In one particular example, the induction heating device is powered solely, and/or directly, by one or more solar panels. In another example, the induction heating device is powered solely, and/or directly, by one or more wind turbines. In another example, the induction heating device may be powered solely and/or directly by one or more hydrogen fuel cells.

The induction heating device may directly heat a radiator to which it is attached. More specifically, the induction heating device may directly heat the outer shell, frame, or main structural components of the radiator to which it is attached. The induction heating device may additionally, or alternatively, indirectly heat the radiator to which it is attached. In these examples, the induction heating device may include heating sub-component such as a heat sink, heat exchanger, heat transfer component, or the like. Such heating sub-components may be directly heated by the induction coil of the induction heating device such that at least part of the radiator is in turn heated by the heating sub-component. The heating sub-component may heat the outer shell, frame, or main structural components of the radiator and/or may heat a fluid residing in an internal cavity or volume of the radiator which in turn may distribute heat throughout the radiator. The heating sub-component may be configured to optimise the efficiency and/or rate of heat transfer from the induction heating device to a radiator.

The induction heating device may include one or more temperature sensors. The one or more temperature sensors may determine the temperature of a radiator to which the induction heating device is attached. Additionally, or alternatively, the one or more temperature sensors may determine the temperature of the housing of the induction heating device, the heating coil of the induction heating device, the ambient air in proximity to the induction heating device, or any combination thereof. Where a plurality of temperature sensors are present, each of the plurality of temperature sensors may determine the temperature of the same material, object, or system component. Alternatively, where a plurality of temperature sensors are present, each of the plurality of temperature sensors may determine the temperature of a different material, object, or system component.

The induction heating device, or heating system in which it is utilised, may include a controller. The controller may operate the induction heating device or heating system. The controller may be operate the induction device or heating system itself and/or be configured to receive instructions to operate the induction heating device or heating system. Operating the induction heating device or heating system may involve turning on the induction heating device, turning off the induction heating device, increasing the rate of heating imparted by the induction heating device, decreasing the rate of heating imparted by the induction heating device, or any combination thereof. Where the controller receives instructions to control the induction heating device or the heating system, the instructions may include heat the radiator, stop heating the radiator, increase the rate of heating of the radiator, decrease the rate of heating of the radiator, or any combination thereof. The controller may include one or more circuit boards configured to control the heating coil of the induction heating device and/or any other function of a heating system as substantially described herein. The controller may include, or be communicably coupled to, a wireless network system configured to receive instructions to operate the induction heating device. Such instructions may be sent from a computer, a phone, tablet, control software, an app, or the like.

The induction heating device or heating system in which it is utilised, may include one or more sensors. The one or more sensors may be in communication with the controller to allow at least one function of the induction heating device or heating system to be at least party automated. One or more sensors may be configured to detect a non-radiator object in proximity to or adjacent to the heating system. Such sensors may form part of a safety system designed to prevent heating from taking place when a person or object that should not be heated is in proximity to the induction heating device or heating system. For example, if a person is standing close to the induction heating device, a metallic part of the person's clothing, such as a button or belt buckle, could be heated by the induction heating device in an undesirable and potentially dangerous manner. The one or more sensors configured to detect a non-radiator object in proximity to or adjacent to the heating system may include an electromagnetic sensor, an electrical current sensor, any other suitable sensor, or any combination thereof. Where a current sensor is used, the sensor may detect changes in the current draw from the induction coil as additional objects are unintentionally heated by the coil. When the sensor detects an increase in current draw beyond that required to heat a radiator to which the induction heating device is attached, the device may be heating an additional object. In these situations, the sensor may communicate with a controller of the induction heating device or heating system which may then stop the induction coil from heating. In such examples, the controller may include a memory which stores the current and/or power draw of the induction heating device relative to the heater it is attached to. The current and/or power draw in the controller memory may then be used as a baseline current or power draw which would cause the induction heating device to stop heating when the baseline is exceeded or exceeded by a threshold. In other examples, a proximity sensor may allow the controller to stop heating when an unexpected object is in proximity to the induction heating system and then restart heating when such an object is no longer detected. The induction heating device and/or heating system with which the induction heating device is used may include a thermostat. The thermostat may detect the temperature of one or more components of the induction heating device, heating system, radiator, ambient environment, or any combination thereof. The thermostat may activate or deactivate the induction heating device when the temperature increases beyond, or falls below, a selected temperature. In a particular example, the thermostat may deactivate the induction heating device at a temperature of 100° C. or less, 80° C. or less, or any other suitable temperature. It may be advantageous for the thermostat to deactivate the induction heating device at a temperature at or below 100° C. to reduce the risk and/or severity of burns being inflicted on a user in the event of accidental contact. More particularly, it may be advantageous for the thermostat to deactivate the induction heating device at or below 50° C., 48° C., 46° C., 44° C., 42° C., 40° C., 38° C., 36° C., 34° C., 32° C., 30° C. or less than 30° C. In other examples, the thermostat may activate the induction heating device at a temperature below −10° C., below −5° C., below 0° C., below 5° C., below 10° C., below 15° C., or any other suitable temperature. It may be advantageous for the thermostat to activate the induction heating device at temperatures of below or equal to 13° C. or 16° C. as these temperatures conform to guidelines for minimum temperatures in a place of work. The temperature at which the thermostat causes the induction heating device to activate or deactivate may be determined or set by a user using a dial, temperature gauge, digital input, or the like. The thermostat may be distant from the induction heating coil. For example, the thermostat may be up to 1 metre, up to 2 metres, up to 3 metres, up to 4 metres, up to 5 metres, up to 6 metres, up to 7 metres, up to 8 metres, up to 9 metres, or up to 10 metres from the induction heating coil. The induction heating device or system may include a boost function. The boost function may cause the induction heating device to activate at a time when it may otherwise not have activated. Additionally, or alternatively, the boost function may cause the induction heating device to heat at an increased rate. The boost function may be initiated by means of a button on the induction heating device that may be pressed by a user. Additionally, or alternatively, where the device includes a controller, the controller may receive an instruction from a networked device or wireless signal that causes it to initiate the boost function. The boost function may be set to operate for a fixed period of time. For example, the boost function may operate for a period of up to 1 minute, up to 2 minutes, up to 3 minutes, up to 4 minutes, up to 5 minutes, up to 10 minutes, up to 15 minutes, or any other suitable period of time. The user may select the period of time that the boost function is activated using one or more interfaces communicably coupled to the controller.

The induction heating device may be used with a radiator. The radiator may be any radiator that may be at least partly heated using an induction heating coil. In an example, the radiator comprises one or more conductive materials. In other examples where the radiator does not include one or more inductive materials, the inductive heating device and/or inductive heating system may include a heating sub-component such as a heat sink, heat exchanger, heat transfer component, or the like as previously described which transfers heat to one or more components of the radiator. The radiator may be formed, at least in part, from one or more metals. The radiator may include a ferrous metal. The radiator be formed from iron, cast iron, steel, mild steel, stainless steel, aluminium, any other ferrous metal, or any combination thereof. Where the induction heating device includes a heating sub-component, the radiator may be formed from other materials such as ceramics although metal radiators as described herein may still be used with such induction heating devices. It may be advantageous to use the induction heating device with a radiator formed from stainless steel due to the high efficiency of heating stainless steel via induction. The radiator may be a standard domestic radiator. A standard domestic radiator is generally a radiator with a height of between 500 mm and 800 mm and a length of between 1250 mm and 2500 mm. Standard domestic radiators are typically made, at least in part, from mild steel, stainless steel, aluminium, or cast iron. The radiator may be a large scale radiator. More particularly, the radiator may be formed from a network of pipes, elements, conduits, grills, vanes, or other structure positioned throughout a room, building, vehicle, outdoor space, or the like. For example, the radiator may be an underfloor element network configured to heat a room from beneath. In another example, the radiator may be an air distribution system configured to distribute hot air throughout a building. The radiator may house one or more fluids. The fluids may include water, oil, air, other gases, or any other suitable fluids. The fluid may be included in the radiator in a closed system wherein fluid may not enter or leave the radiator. Alternatively, the radiator may be part of a fluid system in which fluid may enter, flow through, and then exit the radiator. The induction heating device may heat a portion of a radiator or heating sub-component which then, in turn, heats at least a portion of a fluid in a radiator. The heated portion of fluid may then then transfer heat via convection, causing previously unheated fluid to flow into proximity with the heated portion of the radiator or heating sub-component, causing further fluid to be heated. In this manner, the entire fluid contents of a radiator may be heated using the induction heating device. For the avoidance of doubt, heat may also be transferred to and from a radiator fluid by conduction. In systems where a fluid radiator is part of a wider fluid system, heated fluid may travel from the radiator into other parts of the system. For example, heated fluid may exit the radiator and heat one or more pipes, additional radiators, and the like.

An induction heating system may include one or more induction heating devices and one or more radiators. In systems including a plurality of induction heating devices and or a plurality of radiators, each of the induction heating devices and/or radiators may be substantially identical. Alternatively, two, or more, or all, of the induction heating devices and/or radiators may each be different. In induction heating systems including a plurality of radiators, each radiator may be associated with one or more induction heating devices. In other systems, there may be a greater number of radiators than induction heating devices. In one such example, there may be two radiators for every one induction heating device. In induction heating systems including a plurality of induction heating devices, each induction heating device may be individually controllable. For example, a first induction heating device in a first room may be controllable to heat the first room without activating a second induction heating device to heat a second room.

The induction heating device, and/or induction heating system, may be controlled via an app. In an example, the app may act at least in part as, or form part of, a controller, centralised controller, or the like. The app may allow each induction heating device or induction heating system to be controlled remotely and/or via the internet. The app may allow induction heating devices in separate rooms to be individually activated, or deactivated. The app may communicate with one or more controllers of the induction heating devices and/or heating system to cause the induction heating devices and/or heating system to maintain a particular temperature selected by the user in proximity to one or more induction heating devices. The induction heating devices may determine their power draw and report the information to the app. The app may then display to the user the power consumption of the induction heating device or induction heating system.

Where an induction heating system includes a plurality of induction heating devices, the plurality of induction heating devices may be operable to optimise the heating of the spaces heated by the radiators associated with the plurality of induction heating devices. For example, the plurality of induction heating devices may each be communicably coupled or communicably connected to at least a controller and/or another induction heating device in a network. For example, a particular induction heating device may be in communication with solely a controller, solely another induction heating device, a single induction heating device and a controller, a plurality of induction heating devices, or a controller and a plurality of induction heating devices. In an example, an induction heating device may be in communication with all other induction heating devices on a particular network. The network may be formed using one or more wireless network adaptors, physical network connections such as a wired connections, any other networking apparatus, or any combination thereof. Where the network includes a controller, the controller may be a distinct central controller and the induction heating devices in the induction heating system may each be connected to the distinct central controller directly or indirectly. For example, a particular induction heating device may communicate with another induction heating device which in turn communicates with the controller. Alternatively, one or more of the induction heating devices may act as the central controller such that one or more of the induction heating devices are not connected to a distinct controller that is not also an induction heating device. The network may operate as a mesh network, or hive system in order to efficiently heat the spaces in which the induction heating devices and associated radiators are positioned.

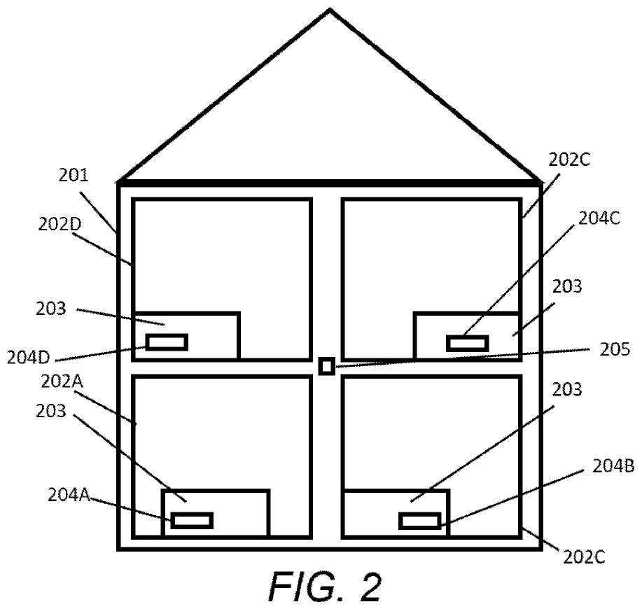

The induction heating system may include one or more temperature sensors, which may be the temperature sensors included in the induction heating devices, where such temperature sensors are present. The controller, central controller, or induction heating device acting as such a controller, within the network may receive temperature information from one temperature sensor, a plurality of temperature sensors, or each temperature sensor and then execute instructions to determine whether the temperature information indicates that the temperature of one or more spaces to be heated by the induction heating system is below a pre-determined temperature threshold. The pre-determined temperature threshold may be a fixed number stored or pre-set in the system, such as a number stored in the controller. Alternatively, a user may set the pre-determined temperature threshold via an interface, thermostat, slider, knob, handle, keypad, keyboard, other interface system, or other input device. When the controller receives temperature information from one or more temperature sensors that indicates that a temperature is below a pre-determined threshold then the controller may send instructions to the induction heating device in closest proximity to, or associated with, the temperature sensor from which the controller received the temperature information. The instructions may activate, turn on, or otherwise cause the induction heating device to heat a radiator with which it is associated in order to increase the temperature of the surroundings of the temperature sensor. Additionally, or alternatively, the controller may send instructions to an induction heating device in response to temperature information below a pre-determined threshold to cause an induction heating device that is already heating a radiator to increase a rate of heating, or to heat the radiator to a greater target temperature. The controller, central controller, or induction heating device acting as a controller may store instructions which, when executed, determine the optimal induction heating device or plurality of induction heating devices to activate and/or to instruct to increase heating rate and/or instruct to heat a radiator to a greater target temperature. In an example, a controller may receive information from multiple temperature sensors which indicate that several spaces associated with those temperature sensors are below a pre-determined temperature threshold. Each space may be below the pre-determined temperature threshold to a different extent. The controller may determine the optimal induction heating device or devices to heat the spaces to meet the pre-determined temperature. The controller may determine the optimal induction heating devices based upon information stored in the controller and/or received from one or more or each induction heating device in the network that defines: the dimensions of the space to be heated; the spatial and/or geographical arrangement, organisation, and relationships between each of the spaces and/or induction heating devices; the size, dimensions, capacity, and/or type of radiator associated with an induction heating device; the type, make, model, or technical specifications of one or more induction heating devices; any other relevant information, or any combination thereof. In an example, the controller, central controller, or induction heating device acting as a controller may determine that activating an induction heating device in a first room to increase the temperature of the first room to a pre-determined temperature may also result in the temperature in a second room in proximity to the first room to become elevated to a pre-determined temperature without the need to activate an induction heating device within the second room. It is envisaged that this principle could be applied to a network of devices forming an induction heating system in a property with multiple rooms, or a building with multiple apartments, to more efficiently heat the property or building in the manner described. Such a system is exemplified and described further in relation to FIG. 2.

The induction heating device and/or induction heating system may be controlled at least in part by one or more electricity suppliers. The electricity supplier may provide information to a controller, server, or the like that indicates a condition is met. The condition may be that excess and/or cheap electricity is available. In another example, the condition may be that the power grid is operating with power available in excess of demand. In yet another example, the condition may be that demand for electricity is low. In a yet further example, the condition may be that electricity is currently cheaper per unit than a pre-determined threshold of costs. A communication link may communicably couple the controller, server, or the like and the induction heating device and/or induction heating system. The communication link may be any suitable communication means described herein. In one example, the controller, server, or the like may be communicably coupled to the induction heating device and/or induction heating system using a connection to the internet. In another example, the controller, server, or the like may be communicably coupled to the induction heating device and/or induction heating system via a telephone network. Other examples include conventional networking hardware such as wireless or ethernet connections, communication via the electricity distribution network, or any other suitable means of communication. The controller, server, or the like may be geographically distant from the induction heating device and/or induction heating system to be controlled. The controller, server, or the like may receive the information and then send a signal to the induction heating device and/or induction heating system to cause the induction heating device and/or induction heating system to turn on and activate the induction heating device, or one or more or each induction heating device of an induction heating system. The induction heating device and/or induction heating system may turn on and begin to heat one or more or each radiator to which the induction heating device and/or induction heating system is associated upon receipt of this signal. In this manner, the induction heating device and/or induction heating system may be used to draw low cost and/or excess electricity from the electrical distribution grid when the condition is met. A home, business, or other property including such an induction heating device and/or induction heating system may therefore benefit from free or reduced cost heating when it is beneficial for a user and/or an electricity supplier to consume electricity via the induction heating device and/or induction heating system. When the condition that had caused the information to be provided to the controller, server, or the like is no longer met, the electricity supplier may send information to the controller, server, or the like indicating that the condition is no longer met. The controller, server, or the like may receive the information and send a further signal based upon the information to the induction heating device and/or induction heating system. The further signal, when received by the induction heating device and/or induction heating system, may cause the induction heating device and/or induction heating system to switch off, deactivate, or cease heating one or more radiators associated with the induction heating device or the one or more or each induction heating device of an induction heating system that had previously been turned on and/or activated. In this manner, an electricity supplier may control periods of activity of the induction heating device and/or induction heating system to coincide with the occurrences of the condition. A user with direct or indirect access to the induction heating device and/or induction heating system may manually override the control of the electricity supplier to cause the induction heating device and/or induction heating system to activate, turn on, or heat when the condition is not met, or to be inactive or turned off when the condition is met. A user may therefore prevent the heating of a home, business, or other property when desirable and similarly may heat the home, business, or other property at periods when the condition is not met.

Where the induction heating system includes a controller, central controller, or the like that is not part of an induction heating device, the controller may include, or may consist of a computing device such as a computer. The computing device may comprise a processor. The computing device may comprise a non-transient computer readable medium. The non-transient computer readable medium may be any electronic, magnetic, optical or other physical storage device that stores executable instructions, sometimes referred to as a memory. Thus, the non-transient computer readable medium may be, for example, Random Access Memory (RAM), and Electrically-Erasable Programmable Read-Only Memory (EEPROM), a storage drive, an optical disc, or the like. A computing device may allow the methods and processes of operation of the induction heating system as described herein to be carried out with minimal or no interaction from a user. In one example, a user may input a start command into the computing device using a switch, user interface, or other input means to start the operation of the induction heating system. Once the start command has been issued, the computing device may carry out the instructions stored on the non-transient computer readable medium to automatically control the heating of a radiator and any associated space by activating and deactivating one or more or each induction heating device of an induction heating system as described herein.

The induction heating devices described herein may be used to retrofit existing radiators to be heated via induction heating. For example, induction heating devices as described herein may be fitted to radiators traditionally used with a centralised gas boiler heating system such that the radiators may be heated without the combustion of natural gas. A method of retrofitting a radiator includes attaching an induction heating device as described herein to a radiator. Once the induction heating device is attached to the radiator, the induction heating device and radiator form an induction heating system.

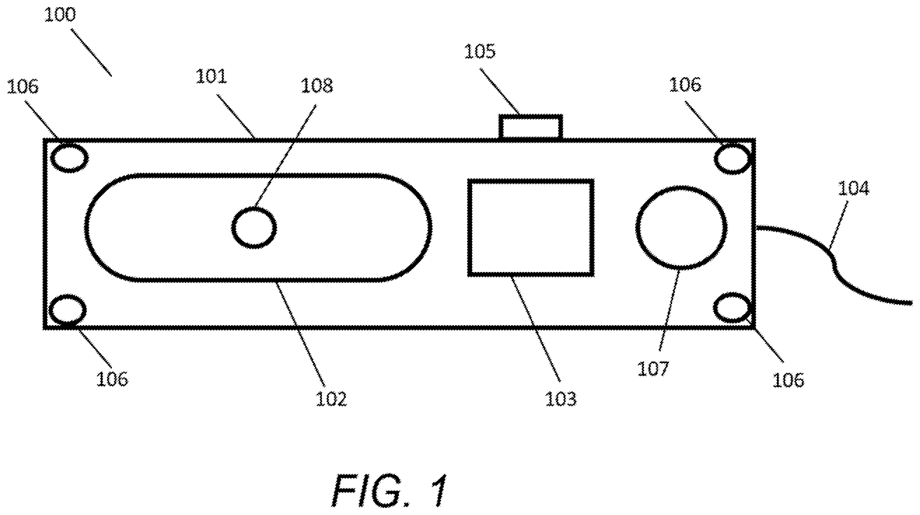

FIG. 1 shows a schematic cross sectional representation of an induction heating device 100. The induction heating device 100 includes a housing 101, an induction heating coil 102 positioned inside the housing, and control circuitry 103 to control the induction heating coil 102. A power supply 104 is attached to the device 100 to provide electrical power. The power supply 104 may be a mains power supply or, alternatively, may be a supply from a renewable energy source such as solar, wind, or the like. In other examples, the power supply may be from a hydrogen fuel cell, battery storage system, or the like. A wireless network antenna 105 is provided to allow remote or wireless control of the induction heating device 100. A user may send instructions over the wireless network which are received by the wireless network antenna 105 and sent to the control circuitry 103 for processing. Four magnet attachments 106 are provided at the corners of the housing 101 to allow attachment to a radiator. A boost button apparatus 107 is provided in proximity to the control circuitry 103 such that a user may manually press the booster button apparatus 107 to activate the induction heating coil 102. A temperature sensor 108 is positioned in proximity to the induction heating coil 102 to measure the temperature of the coil and/or the radiator to which the induction heating device 100 is attached. The temperature sensor 108 is communicably coupled to the control circuitry 103 to allow automatic control of temperature and the reporting of temperature to a user via the wireless network antenna 105.

FIG. 2 shows a building 201 including a plurality of spaces 202A-202D. The spaces 202A-202D may be individual rooms in a property or, alternatively, may be individual properties such as apartments or flats with a single building 201. Each of the spaces 202A-202D includes at least one radiator 203 with an associated induction heating device 204A-204D. Although each space shown in FIG. 2 includes a single induction heating device 204A-204D and a single radiator 203, each space may contain a plurality of induction heating devices and/or radiators. The plurality of induction heating devices 204A-204D forms an induction heating system. The induction heating devices 204A-204D are communicably coupled to the central controller 205 to form a hive network. However, the skilled person, with the benefit of this disclosure, will appreciate that the central controller 205 is optional and that the induction heating devices 204A-204D may be communicably coupled to each other to form mesh network or hive network without the need for a separate central controller. In examples where the central controller 205 is absent, at least one of the induction heating devices 204A-204D may assume the function and role of the central controller 205 as described herein. The central controller 205 stores information that indicates a target temperature for each of the spaces 202A-202D. A user may interact with the controller via an interface, app, or other means of interaction to modify, adjust, or alter the target temperature for each space 202A-202D. The controller receives temperature information from one or more temperature sensors (not shown) forming part of the induction heating system. As described herein, one or more or each induction heating device 204A-204D may include a temperature sensor which allows temperature information to be sent to the central controller 205 via the communicative coupling of the induction heating device and the central controller. The central controller 205 compares temperature information collected by the temperature sensors against the target temperature for each of the spaces 202A-202D to determine whether additional heating is needed in one or more of the spaces 202A-202D. If the central controller 205 determines that additional heating is needed in one or more of the spaces 202A-202D then the central controller sends instructions to one or more of the induction heating devices 204A-204D to heat a radiator 203 which in turn heats the surrounding space 202A-202D. If the central controller 205 receives information that indicates that two or more spaces 202A-202D are below the target temperature, then then controller determines the optimal heating pattern of induction heating devices 204A- 204D to heat the space. In an example, the central controller 205 may receive temperature information from temperature sensors associated with induction heating devices 204A and 204D that indicates that spaces 202A and 202D are below a target temperature. The controller may determine that activation of induction heating device 204A alone will sufficiently increase the temperature of spaces 202A and 202D to the target temperature without the need to activate induction heating device 202D. In another example, the central controller 205 may receive temperature information that indicates that each of the spaces 202A-202D are below the target temperature to different extents. The central controller 205 may send instructions to a combination of the induction heating devices 202A-202D that causes them to activate and heat the radiators 203 in each space 202A-202D for different amounts of time, respectively, such that the temperature in each space 202A-202D is increased to the target temperature without overheating any of the space, consuming more energy than is needed, or causing the temperature in any one space 202A-202D to exceed the target temperature by a particular extent. In this example, the controller may send instructions to activate each of the induction heating devices 204A-204D or, alternatively, may not activate one or more of the induction heating devices 204A-204D. While FIG. 2 shows only four spaces 202A-202D and four induction heating devices 204A-204D, the skilled person with the benefit of this disclosure will appreciate that the principles exemplified therein may be extended to any number of spaces and induction heating devices.

The skilled person, with the benefit of this disclosure, will appreciate that the induction heating device and system described herein provides numerous advantages over other known systems. The induction heating device allows systems that had previously been heated by the combustion of natural gas or fossil fuels to instead be heated using electricity. Use of renewable energy to provide the electricity may remove all combustion of fossil fuels from the heating of the radiator from the energy generation step down to heating the radiator/fluid itself. The devices and systems described herein may also be highly efficient. For example, where materials such as stainless steel are used in the construction of a radiator, an induction heating device may heat such a radiator at an efficiency of up to 95%. The induction heating devices also allow existing heating systems to be retrofitted to operate using induction heating with relative ease.

1. A heating system comprising:
a radiator; and
an induction heating device attachable to the radiator, the induction heating device configured to heat at least a portion of the radiator via induction.

2. A heating system according to claim 1, wherein the induction heating device is removably attached to the exterior of the radiator.

3. A heating system according to claim 1, wherein the radiator comprises a ferrous metal and the induction heating device is attached to the radiator using one or more magnets.

4. A heating system according to claim 1, wherein the induction heating device is configured to at least partly detach from the radiator at a fail-safe temperature, optionally wherein the induction heating device is attached to the radiator using one or more magnets and at least one of the one or more magnets detaches from the radiator at the fail-safe temperature.

5. A heating system according to claim 1 wherein the induction heating device is integral to the radiator.

6. A heating system according to claim 1, wherein the induction heating device has a power rating of less than 1500 W, optionally wherein the induction heating device has a power rating of less than 500 W, less than 400 W, less than 300 W, or less than 200 W.

7. A heating system according to claim 1, wherein the induction heating device comprises a heat sink configured to transmit heat to at least a portion of the radiator.

8. A heating system according to claim 1, wherein the radiator comprises iron, cast iron, steel, mild steel, stainless steel, aluminium, any other ferrous metal, or any combination thereof, optionally wherein the radiator comprises stainless steel.

9. A heating system according to claim 1, wherein the radiator houses a fluid and the induction heating device is configured to heat the fluid housed in the radiator.

10. A heating system according to claim 1, wherein the system comprises a controller configured to receive instructions to operate the heating system.

11. A heating system according to claim 10, wherein the instructions comprise instructions to heat the radiator, stop heating the radiator, increase the rate of heating of the radiator, decrease the rate of heating of the radiator, or any combination thereof.

12. A heating system according to claim 1, further comprising one or more sensors configured to detect a non-radiator object in proximity to or adjacent to the heating system, optionally wherein the one or more sensors comprise an electromagnetic sensor, and/or an electrical current sensor.

13. A heating system according to claim 1, comprising one or more temperature sensors configured to detect the temperature of the radiator, the ambient environment in proximity to the radiator, or any combination thereof.

14. A heating system according to claim 13, wherein the system is configured to maintain the temperature of the radiator and/or ambient environment in proximity to the radiator within a first temperature range.

15. A heating system according to claim 14 wherein the first temperature range is from 20° C. to 70° C., optionally wherein the first temperature range is from 30° C. to 45° C.

16. A heating system according to claim 15, wherein the first temperature range is a temperature range defined by the user.

17. A heating system according to claim 1, wherein the induction heating device is controlled remotely via an app.

18. A heating system according to claim 1, wherein the heating system comprises a plurality of radiators and a plurality of induction heating devices, optionally wherein each of the plurality of radiators and each of the plurality of induction heating devices are substantially identical.

19. A heating system according to claim 18, wherein each of the plurality of induction heating devices are individually controllable.

20. (canceled)

21. An induction heating device comprising the heating system according to claim 1, wherein the induction heating device comprises:
a housing; and
a heating coil at least partially contained within the housing.

22. An induction heating device according to claim 20, the induction heating device further comprising:
a temperature sensor; and/or
a boost system comprising a boost button configured to activate the induction heating device; and/or
one or more circuit boards configured to control the heating coil and/or the boost system; and/or
a wireless network system configured to receive instructions to operate the induction heating device.

23. An induction heating device according to claim 21, the induction heating device further comprising an electrical power supply, optionally wherein the electrical power supply is powered solely by renewable energy sources.

24. A method of retrofitting a radiator, the method comprising attaching an induction heating device to a radiator to provide a heating system as defined in claim 1.

25. A method according to claim 24, wherein the radiator is compatible with a gas boiler heating system.
